(19) United States
(12) Patent Application Publication
(10) Pub. No.: US 2025/0092950 A1
(43) Pub. Date: Mar. 20, 2025

(54) PISTON-CYLINDER UNIT, METHOD FOR PRODUCING THE PISTON-CYLINDER UNIT

(71) Applicant: STABILUS GMBH, Koblenz (DE)

(72) Inventors: Hermann Schneider, Koblenz (DE); Rainer Sauer, Mayen (DE); Frank Born, Lahnstein (DE); Martin Schleich, Saffig (DE)

(21) Appl. No.: 18/288,169

(22) PCT Filed: Jan. 3, 2023
(86) PCT No.: PCT/EP2023/050043

§ 371 Date: Oct. 24, 2023

(51) Int. Cl. F16J 15/324; C09K 3/10; C10M 107/02; C10M 107/34; C10M 129/68; C10M 169/04; C10N 30/00; C10N 30/12; C10N 40/25; F16J 1/08; F16J 7/00; F16J 15/3284

(52) U.S. Cl. CPC F16J 15/324; C09K 3/10; C10M 107/02; C10M 107/34; C10M 129/68; C10M 169/04; F16J 1/08; F16J 7/00; F16J 15/3284; C09K 2003/1096; C09K 2200/0612; C10M 2205/0206; C10M 2207/28; C10M 2209/1033; C10N 2030/12; C10N 2030/36; C10N 2040/25

(57) ABSTRACT

The invention relates to a piston-cylinder unit (100) comprising a cylinder (110) filled with a fluid (150), a piston (120) slidably guided in the cylinder (110), a piston rod (130) attached to the piston (120), a seal (140), and a lubricant in contact with the seal (140) and with the cylinder (110), the piston (120) and/or the piston rod (130). The lubricant is a polyalphaolefin oil or a polyalkylene glycol oil. The seal (140) is made of chlorine-free acrylonitrile butadiene rubber. The invention also relates to a method for producing the piston-cylinder unit (100).

### BACKGROUND

### Technical Field

The invention relates to a piston-cylinder unit comprising a cylinder filled with a fluid, a piston slidably guided in the cylinder, a piston rod attached to the piston, a seal, and a lubricant in contact with the seal and with the cylinder, the piston and/or the piston rod. The invention also relates to a method for producing the piston-cylinder assembly.

### State of the Art

The publications DE 294 20 29 A1, EP 325 80 56 B1 and WO 2006 007 087 A1 show examples of piston-cylinder units of the aforementioned type in the form of gas springs.

In known piston-cylinder units, a mineral oil is usually used as a lubricant. This results in the disadvantage that when the piston moves in the cylinder of the piston-cylinder unit for the first time after a longer storage time, there is increased initial friction and associated increased wear, which impairs the service life of the piston-cylinder unit.

### Technical Problem

The object of the invention is to provide a low-cost and durable piston-cylinder unit with low friction, especially after an extended storage time.

### Technical Solution

The present invention provides a piston-cylinder unit according to claim 1 that solves the technical problem. Likewise, the problem is solved by a method for producing the piston-cylinder unit according to claim 7. Advantageous embodiments are subject of the dependent claims.

The piston-cylinder unit comprises a cylinder filled with a fluid. The piston-cylinder unit is designed, for example, as a gas pressure spring or as a hydraulic damper. The fluid is, for example, a gas, in particular nitrogen, which can have an overpressure relative to an environment of the cylinder. The cylinder is preferably hollow cylindrical in shape and can be made of a metal, in particular of steel.

The piston-cylinder unit comprises a piston which is slidably guided in the cylinder, preferably along a longitudinal axis of the cylinder, and which preferably divides the cylinder into two chambers. The piston can be made of a plastic, in particular of a thermoplastic, or of a metal, in particular of zinc or of aluminium.

The piston-cylinder unit comprises a piston rod attached to the piston, which is preferably arranged coaxially to the central longitudinal axis of the cylinder. The piston rod can be made of a metal, in particular of steel.

The piston-cylinder unit comprises at least one seal, in particular for fluid-tight sealing of the cylinder against an environment of the cylinder and/or for fluid-tight sealing of the chambers of the cylinder against each other.

The piston-cylinder unit comprises a lubricant in contact with the seal and with the cylinder, with the seal and with the piston and/or with the seal and with the piston rod for reducing friction between the seal and the cylinder and/or between the seal and the piston and/or between the seal and the piston rod.

The lubricant is a polyalphaolefin oil, also called PAO oil, or a polyalkylene glycol oil, also called PAG oil or polyglycol oil. A polyalphaolefin oil is a synthetic oil which consists of at least 50%, in particular at least 75%, preferably 85% to 95% polyalphaolefins. A polyalkylene glycol oil is a synthetic oil which consists of at least 50%, in particular at least 75%, preferably 85% to 95% polyalkylene glycols.

The seal is made of acrylonitrile butadiene rubber, also called AB rubber, NBR, nitrile butadiene rubber or nitrile rubber. The acrylonitrile butadiene rubber is chlorine-free, i.e. the seal does not contain chlorine or chlorine compounds that have been deliberately added, nor does it contain chlorine or chlorine compounds that have been transferred to the seal during the manufacture of the seal, for example from auxiliary materials such as reaction retarders.

### Beneficial Effects

Tests have shown that the initial friction of the piston-cylinder unit is reduced after a longer storage time if a synthetic oil selected from a polyalphaolefin oil and a polyalkylene glycol oil is used as a lubricant instead of a conventional mineral oil. However, increased corrosion of the piston-cylinder unit was observed in conjunction with a conventional seal made of acrylonitrile-butadiene rubber compared to the use of a mineral oil.

Common seals made of acrylonitrile-butadiene rubber contain chlorine compounds, for example from—usually chlorine-containing—reaction retarders used in the manufacture of the seals. Reaction retarders are necessary to produce the seal by injection moulding or compression moulding from an acrylonitrile-butadiene rubber melt without the melt solidifying prematurely.

Surprisingly, the piston-cylinder unit according to the invention shows reduced initial friction without increased corrosion compared to conventional piston-cylinder units when a polyalphaolefin oil or a polyalkylene glycol oil is used as lubricant and the seal is made of chlorine-free acrylonitrile-butadiene rubber.

Thus, the combination of lubricant and material of the seal according to the invention leads to a cost-effective and long-lasting piston-cylinder unit with reduced friction, especially after longer storage times.

### DESCRIPTION OF PREFERRED EMBODIMENTS

The seal is preferably a piston rod seal, whereby the piston rod is guided out of the cylinder through the seal, in particular coaxially to the central longitudinal axis of the cylinder, and the seal closes the cylinder tightly to the fluid. The previously described problem of increased initial friction occurs particularly strongly at the piston rod seal, so that the aforementioned advantages of the invention are particularly prominent here.

The seal is preferably halogen-free. As the seal not only contains no chlorine, but also no other halogens or halogen compounds, corrosion by halogens or halogen compounds can be excluded. In this embodiment, the seal contains neither deliberately added halogens or halogen compounds nor halogens or halogen compounds unintentionally transferred into the seal during manufacture.

The lubricant preferably contains at least one swelling additive for swelling the seal, wherein the swelling additive is an ester. The ester is preferably soluble in the polyalphaolefin oil or polyalkylene glycol oil and does not chemically interact with the polyalphaolefin oil, polyalkylene glycol oil or additives contained therein under operating conditions of the piston-cylinder unit.

In contact with a polyalphaolefin oil or polyalkylene glycol oil, an acrylonitrile butadiene rubber seal may shrink. Shrinkage can impair the sealing effect of the seal and lead to leakage. This effect is prevented by the swell additive.

The lubricant preferably contains at least one friction reducing additive for reducing friction between the seal and the cylinder, the piston and/or the piston rod, wherein the friction reducing additive is an amphiphilic substance, a functionalised polymer, an organic molybdenum compound or a fatty acid ester.

The friction reducing additive can reduce friction, for example, by forming a boundary layer between the lubricant and the seal, cylinder, piston and/or piston rod.

The lubricant preferably contains at least one anti-corrosion additive for reducing corrosion of the cylinder, the piston and/or the piston rod, wherein the anti-corrosion additive is a sulphonate, a cycloalkanate, a carboxylate, an alkyl succinic acid derivative or a polyol ester.

The corrosion protection additive acts, for example, like a non-ferrous metal deactivator and forms a water-impermeable protective film on a surface of the cylinder, the piston and/or the piston rod. The corrosion protection additive may be suitable for neutralising acidic reaction products, for example from the degradation of additives.

If the lubricant contains the anti-corrosion additive and the friction-reducing additive, there may be competition between the two additives for occupation of the surface of the cylinder, the piston and/or the piston rod.

Due to the low corrosion tendency of the piston-cylinder unit according to the invention, good corrosion protection can be achieved even if the lubricant contains only a small amount of the corrosion protection additive. Since the anti-corrosion additive in these embodiments competes only slightly with the polyalphaolefin oil, the polyalkylene glycol oil or a friction-reducing additive for occupation of the surface of the cylinder, the piston and/or the piston rod, a particularly low friction is achieved in these embodiments.

Even with a piston-cylinder unit according to the invention, the corrosion protection additive is advantageously not completely dispensed with, since water can possibly penetrate the piston-cylinder unit during operation of the piston-cylinder unit due to hydrodynamic effects. Without corrosion protection additive, this water could lead to corrosion, especially on an inner surface of the cylinder.

The method according to the invention is used for producing a piston-cylinder unit according to the invention and comprises a chlorine-free manufacture of the seal of the piston-cylinder unit from acrylonitrile-butadiene rubber.

The method comprises, preferably after the manufacture of the seal, an assembly of the seal with the cylinder, the piston, and the piston rod of the piston-cylinder unit.

The method comprises, preferably after the assembly rod of the piston-cylinder unit, a filling of the piston-cylinder unit with the lubricant of the piston-cylinder unit, wherein the lubricant is a polyalphaolefin oil or a polyalkylene glycol oil.

The mentioned process steps result in the above-mentioned advantages and design possibilities of the piston-cylinder unit according to the invention.

The manufacture of the seal preferably comprises retarding solidification of an acrylonitrile-butadiene rubber melt with a chlorine-free reaction retarder.

The use of a reaction retarder allows the melt to be formed into the seal, for example by injection moulding or transfer moulding, without the melt solidifying prematurely or requiring additional heating to prevent it from solidifying. If the reaction retarder is chlorine-free, in particular halogen-free, the above-mentioned advantages of the chlorine-free, in particular halogen-free, seal result.

According to the invention, the increased costs of the chlorine-free reaction retarder compared to chlorine-containing reaction retarders can be compensated, for example, by a reduced need for corrosion protection additive and/or an extended service life of the piston-cylinder unit due to reduced corrosion.

The manufacture of the seal preferably includes injection moulding or injection compression moulding of the seal from an acrylonitrile-butadiene rubber melt. These processes have the advantages that the seal can be produced in almost any shape fully automatically, quickly, and cost-effectively.

### BRIEF DESCRIPTION OF THE DRAWINGS

Further advantages, objectives and properties of the invention are explained with reference to the following description and accompanying drawings, in which exemplary embodiments of the invention are shown.

FIG. 1 shows a schematic representation of a piston-cylinder unit according to the invention.

FIG. 2 shows the friction force acting on the piston rod of a piston-cylinder unit with a mineral oil or with a polyalkylene glycol oil as lubricant.

FIG. 3 shows the degree of corrosion of steel fingers in contact with a polyalkylene glycol oil lubricant with a seal of chlorine-containing or chlorine-free acrylonitrile butadiene rubber.

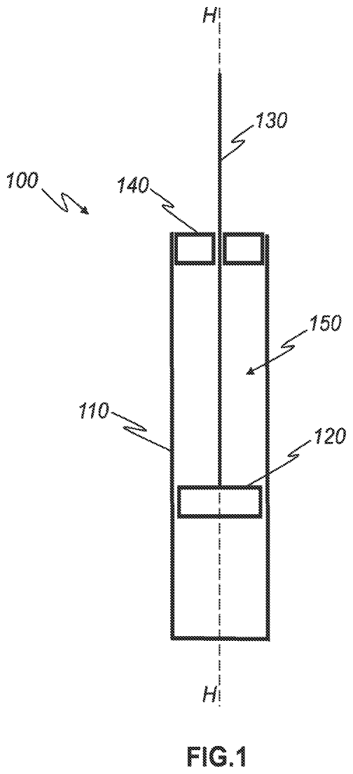

FIG. 1 shows a schematic representation of a piston-cylinder unit 100 according to the invention as a longitudinal section along a stroke axis H of the piston-cylinder unit 100, which is for example a gas pressure spring.

The piston-cylinder unit 100 shown comprises a cylinder 110 filled with a fluid 150, for example with nitrogen gas that is at an overpressure relative to an environment of the cylinder 110, and a piston 120 guided in the cylinder 110 so as to be displaceable along the stroke axis H.

The illustrated piston-cylinder unit 100 includes a piston rod 130 attached to the piston 120 and a seal 140. The seal 140 is, for example, a piston rod seal, wherein the piston rod 130 extends out of the cylinder 110 through the seal 140, and the seal 140 closes the cylinder 110 tightly to the fluid 150.

The illustrated piston-cylinder assembly 100 includes a lubricant (not shown) at least in contact with the seal 140 and the piston rod 130.

The lubricant is a polyalphaolefin oil or a polyalkylene glycol oil, and the seal 140 is made of chlorine-free acrylonitrile butadiene rubber.

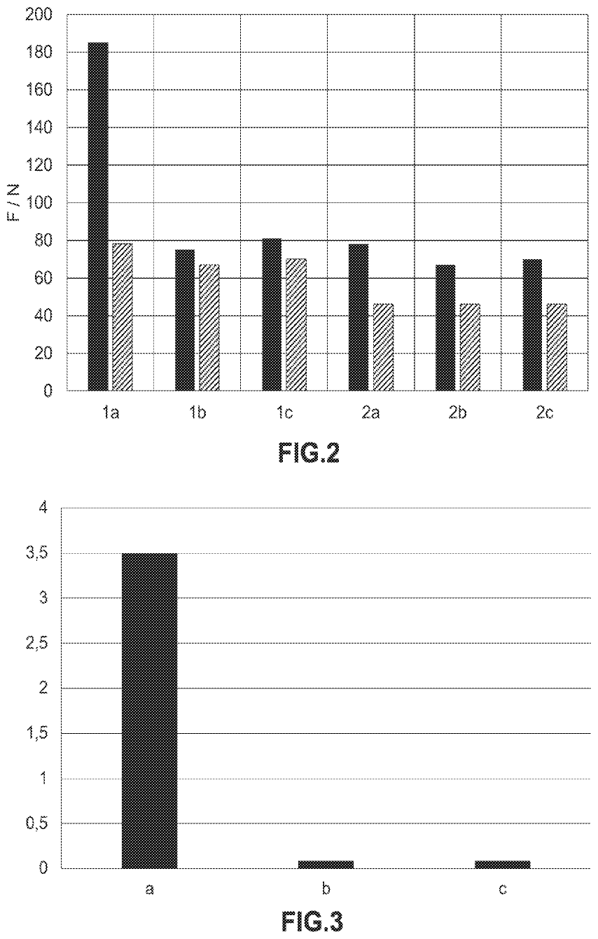

FIG. 2 shows the frictional force Fin N acting on the piston rod of a prior art piston-cylinder unit designed as a gas pressure spring with a mineral oil (black columns) or a polyalkylene glycol oil (hatched columns) as lubricant.

The friction force F at the first stroke 1a, at the second stroke 1b and at the third stroke 1c directly after assembly of the piston-cylinder unit as well as the friction force F at the first stroke 2a, at the second stroke 2b and at the third stroke 2c after the piston-cylinder unit has been subjected to an endurance test and then stored for 24 h, so that the surface of the piston rod is dry at the first stroke in each case, are shown.

The friction force Fis lower with the polyalkylene glycol oil than with the mineral oil. This effect is particularly strong during the first stroke after assembly and after storage and can also be seen during the subsequent strokes.

FIG. 3 shows the degree of corrosion of steel fingers in contact with a polyalkylene glycol oil lubricant in which a seal of chlorine-containing (a) or chlorine-free (b, c) acrylonitrile butadiene rubber is inserted.

The degree of corrosion is determined using a steel finger test based on DIN ISO 7120, method B. In this test, a steel pin is suspended in a glass with the seal, the polyalkylene glycol oil and water. After a predetermined reaction time of, for example, 24 h at a constant temperature of, for example, 60° C., the degree of corrosion is evaluated on a scale from 0 (no corrosion) to 5 (complete corrosion of the surface of the steel pin).

While the steel pin shows a high degree of corrosion in contact with the polyalkylene glycol oil with a chlorine-containing seal, the degree of corrosion under the same conditions is much lower in contact with the polyalkylene glycol oil with a chlorine-free seal.

List of reference signs

| | | | |
|---|---|---|---|
| 100 | Piston-cylinder unit | 140 | Seal |
| 110 | Cylinder | 150 | Fluid |
| 120 | Piston | F | Frictional force |
| 130 | Piston rod | H | Stroke axis |

We claim:

1. A piston cylinder unit (100) comprising
a. a cylinder (110) filled with a fluid (150),
b. a piston (120) slidably guided in the cylinder (110),
c. a piston rod (130) attached to the piston (120),
d. a seal (140) made of acrylonitrile butadiene rubber and
e. a lubricant in contact with the seal (140) and with the cylinder (110), the piston (120) and/or the piston rod (130),
characterised in that
f. the lubricant is a polyalphaolefin oil or a polyalkylene glycol oil, and
g. the seal (140) is chlorine-free, wherein the seal (140) contains neither chlorine or chlorine compounds added intentionally, nor chlorine or chlorine compounds transferred into the seal (140) during manufacture of the seal (140).

2. The piston-cylinder unit (100) according to claim 1, characterized in that the seal (140) is a piston rod seal, wherein
a. the piston rod (130) is led out of the cylinder (110) through the seal (140), and
b. the seal (140) closes the cylinder (110) tightly for the fluid (150).

3. The piston-cylinder unit (100) according to claim 1, characterized in that
the seal (140) is halogen-free, wherein the seal (140) contains neither halogens or halogen compounds added intentionally, nor halogens or halogen compounds transferred into the seal (140) during manufacture of the seal (140).

4. The piston-cylinder unit (100) according to claim 1, characterized in that
the lubricant contains at least one swelling additive for swelling the seal (140), wherein the swelling additive is an ester.

5. The piston-cylinder unit (100) according to claim 1, characterized in that
the lubricant contains at least one friction reducing additive for reducing friction between the seal (140) and the cylinder (110), the piston (120) and/or the piston rod (130),
wherein the friction reducing additive is an amphiphilic substance, a functionalised polymer, an organic molybdenum compound or a fatty acid ester.

6. The piston-cylinder unit (100) according to claim 1, characterized in that
the lubricant contains at least one anti-corrosion additive for reducing corrosion of the cylinder (110), the piston (120) and/or the piston rod (130), wherein the anti-corrosion additive is a sulphonate, a cycloalkanate, a carboxylate, an alkyl succinic acid derivative or a polyol ester.

7. A method for producing a piston-cylinder unit (100) according to claim 1, characterized by the following steps:
a. chlorine-free manufacture of the seal (140) of the piston-cylinder unit (100) from acrylonitrile-butadiene rubber, so that the seal (140) contains neither chlorine or chlorine compounds added deliberately, nor chlorine or chlorine compounds transferred into the seal (140) during the manufacture of the seal (140),
b. assembly of the seal (140) with the cylinder (110), the piston (120) and the piston rod (130) of the piston-cylinder unit (100) and
c. filling of the lubricant of the piston-cylinder unit (100) into the piston-cylinder unit (100), wherein the lubricant is a polyalphaolefin oil or a polyalkylene glycol oil.

8. The method of claim 7,
characterized in that s
aid the manufacture of the seal (140) comprises retarding solidification of an acrylonitrile-butadiene rubber melt with a chlorine-free reaction retarder.

9. The method of claim 7, characterised in that the manufacture of the seal (140) comprises injection moulding or injection compression moulding the seal (140) from an acrylonitrile-butadiene rubber melt.
